(19) United States
(12) Patent Application Publication
(10) Pub. No.: US 2025/0392865 A1
(43) Pub. Date: Dec. 25, 2025

(54) AUDIO SYSTEM CONTROL METHOD AND AUDIO SYSTEM

(71) Applicant: Realtek Semiconductor Corp., HsinChu (TW)

(72) Inventors: Huan Sun, Suzhou City (CN); XIAODAN XU, Suzhou City (CN); Siyuan Wang, Suzhou City (CN)

(73) Assignee: Realtek Semiconductor Corp., HsinChu (TW)

(21) Appl. No.: 19/243,714

(22) Filed: Jun. 20, 2025

(30) Foreign Application Priority Data
Jun. 25, 2024 (CN) 202410832104.2

(51) Int. Cl. H04R 3/12

(52) U.S. Cl. CPC H04R 3/12; H04R 2420/07

(57) ABSTRACT

An audio system control method, comprising: (a) establishing an OOB wireless communication channel between a first audio playing device and a second audio playing device; (b) computing a first time difference between a current time point and a first expected playing time point, when the first audio playing is ready to play the audio data; (c) sending a ready notification to the second audio playing device through the OOB wireless communication channel if the current time point is before the first expected playing time point; (d) sending a start playing notification to notify the first audio playing device to start playing, if the second audio playing device has received the ready notification, has received the audio data output by the audio source device and is ready to play the audio data; and (e) playing the audio data after the first audio playing device receiving the start playing notification.

### BACKGROUND OF THE INVENTION

### 1. Field of the Invention

The present invention relates to an audio system control method and an audio system, and particularly relates to an audio system control method and an audio system which can reduce audio playing delay.

### 2. Description of the Prior Art

With the advancement of science and technology, Bluetooth earphones are becoming more and more popular. However, if different Bluetooth earphones in a pair have different capabilities, the earphone with the higher performance will slow down its audio playing speed in order to synchronize with the earphone with lower performance to follow the Bluetooth protocol. Accordingly, the entire pair of Bluetooth earphones will have a greater delay when playing audio.

For example, BLE Audio introduces the concepts of SDU (Service Data Unit) synchronization reference and presentation delay to synchronize the play time points of different earphones in the BLE Audio network. However, such algorithm will match the weakest device, which may waste the performance of earphones with better hardware in the network. At the same time, such algorithm will configure the earphone parameters when the BLE Audio network is established, and does not support the function of dynamically adjusting the earphone parameters.

Therefore, a new audio system control method and audio system are needed to improve this problem.

### SUMMARY OF THE INVENTION

One objective of the present invention is to provide an audio system control method, to synchronize different audio playing devices by a less restrictive method.

Another objective of the present invention is to provide an audio system, to synchronize different audio playing devices by a less restrictive method.

One embodiment of the present invention discloses an audio system control method, which is applied to an audio system comprising a first audio playing device and a second audio playing device. The audio system control method comprises: (a) establishing an OOB (out of band) wireless communication channel between the first audio playing device and the second audio playing device; (b) computing a first time difference between a current time point and a first expected playing time point, when the first audio playing device has received audio data output from an audio source device and is ready to play the audio data; (c) the first audio playing device sending a ready notification to the second audio playing device through the OOB wireless communication channel if the current time point is before the first expected playing time point, wherein the ready notification represents that the first audio playing device is in a ready state; (d) sending a start playing notification to the first audio player through the OOB wireless communication channel to notify the first audio playing device to start playing, if the second audio playing device has received the ready notification, has received the audio data output by the audio source device and is ready to play the audio data; and (e) the first audio playing device and the second audio playing device start playing the audio data after the first audio playing device receiving the start playing notification.

Another embodiment of the present invention discloses an audio system control method, applied to an audio system comprising a plurality of audio playing devices, comprising: (a) establishing a wireless communication channel between the audio playing devices and an audio source device; (b) the audio playing devices respectively sending a ready notification to the audio source device through the wireless communication channel if the audio playing devices have received first audio data from the audio source device and are ready to play the first audio data, wherein the ready notification represents that the audio playing devices are in a ready state; and (c) generating a control command to the audio playing devices to control the audio playing devices to start playing the first audio data, when the audio source device confirms that all of the audio playing devices are in the ready state.

In view of above-mentioned embodiments, the synchronization of different Bluetooth earphones is not limited by the presentation delay in the Bluetooth protocol, which can improve the problem in the prior art that the performance of all Bluetooth earphones is limited by Bluetooth earphones with a lower performance.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a schematic diagram illustrating an audio system control method according to one embodiment of the present invention.

FIG. 2 is a schematic diagram illustrating presentation delay.

FIG. 3 is a schematic diagram illustrating an audio system control method according to another embodiment of the present invention.

FIG. 4A and FIG. 4B are detail flow charts of operations of the audio system in FIG. 1 and FIG. 2, according to one embodiment of the present application.

FIG. 5 is a flow chart illustrating an audio system control method according to one embodiment of the present invention.

FIG. 6 is a schematic diagram illustrating an audio system control method according to another embodiment of the present invention.

FIG. 7 is a detail flow chart of operations of the audio system in FIG. 6, according to one embodiment of the present application.

FIG. 8 is a flow chart illustrating an audio system control method according to another embodiment of the present invention.

### DETAILED DESCRIPTION

In the following descriptions, several embodiments are provided to explain the concept of the present application. It will be appreciated that the system, the device, the apparatus or the module depicted in following embodiments can be implemented by hardware (ex. circuit) or the combination of hardware and software (ex. a processing unit executing at least one program). The term “first”, “second”, “third” in following descriptions are only for the purpose of distinguishing different one elements, and do not mean the sequence of the elements. For example, a first device and a second device only mean these devices can have the same structure but are different devices.

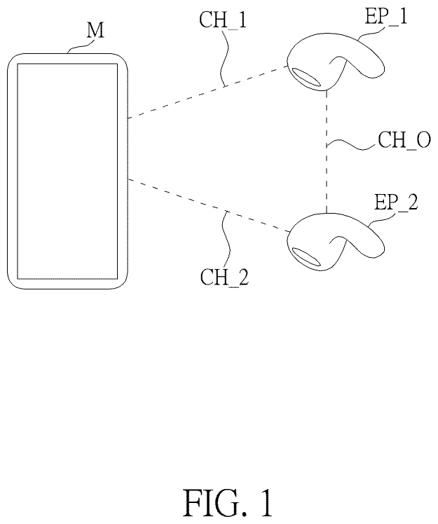

FIG. 1 is a schematic diagram illustrating an audio system control method according to one embodiment of the present invention. As shown in FIG. 1, the audio system comprises a first audio playing device EP_1 and a second audio playing device EP_2. The first audio playing device EP_1 and the second audio playing device EP_2 may receive audio data from an audio source device M. In one embodiment, the audio source device M is a mobile device (such as a mobile phone), and the first audio playing device EP_1 and the second audio playing device EP_2 are Bluetooth earphones. In one embodiment, the audio source device and the audio playing device of the present invention use the Bluetooth protocol of BLE Audio. However, please note that the audio source device and audio playing device in the present invention can be replaced by other electronic devices rather than limited to mobile devices and wireless earphones, and can follow other protocols.

In the embodiment of FIG. 1, an OOB (Out Of Band) wireless communication channel CH_O is established between the first audio playing device EP_1 and the second audio playing device EP_2. In one embodiment, the OOB wireless communication channel CH_O is a channel using non-Bluetooth technology, such as a 5G OOB channel in Wifi technology. The advantage of using 5G technology is that moisture will not strongly shield or interfere with 5G. Since the main component of the human body is water, the interference of the human body is relatively large for wireless earphones. Using 5G OOB can avoid the interference of the human body.

Wireless communication channels CH_1 and CH_2 are also established respectively between the first audio playing device EP_1, the second audio playing device EP_2 and the audio source device M. Since the first audio playing device EP_1 and the second audio playing device EP_2 are Bluetooth earphones, the wireless communication channels CH_1 and CH_2 are wireless communication channels that follow the Bluetooth protocol. That is, in one embodiment, the wireless communication channels CH_1 and CH_2 can use a wireless communication channel that follows a first protocol, and the OOB wireless communication channel CH_O can use a wireless communication channel that follows a second protocol. The first protocol and the second protocol are different.

After establishing the OOB wireless communication channel CH_O, the first audio playing device EP_1 computes a first time difference between a current time point and a first expected playing time point, when the first audio playing device EP_1 has received audio data output from an audio source device and is ready to play the audio data. The first audio playing device EP_1 sends a ready notification to the second audio playing device EP_2 through the OOB wireless communication channel if the current time point is before the first expected playing time point, wherein the ready notification represents that the first audio playing device is in a ready state. In one embodiment, the first audio play device EP_1 computes the first expected playing time point based on the current time point and a presentation delay specified in the Basic Audio Profile in the Bluetooth protocol. In such case, the first expected playing time point may also be called a render point.

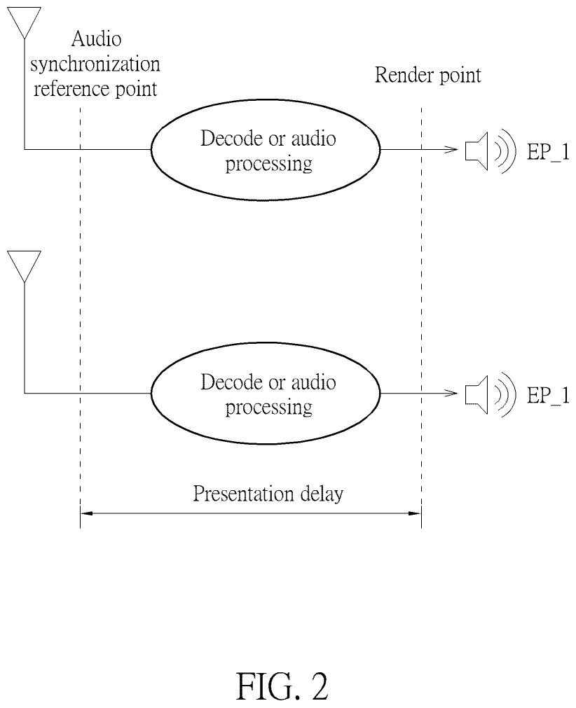

FIG. 2 is a schematic diagram illustrating presentation delay. As shown in FIG. 2, in the Bluetooth protocol, the time points at which the first audio playing device EP_1 and the second audio playing device EP_2 receive audio data are synchronized, such as receiving audio data at an audio synchronization reference point. Audio data may be in the form of SDU. Since the first audio playing device EP_1 and the second audio playing device EP_2 will decode and process the audio data (such as resampling or equalization) after receiving the audio data, there will be a period of delay time between the render point and the audio synchronization reference point. In the basic audio specification, a presentation delay is determined based on the performance of the first audio playing device EP_1 and the second audio playing device EP_2, so that the first audio playing device EP_1 and the second audio playing device EP_2 can process the audio data and allow the render point synchronous. As mentioned above, the presentation delay must match the performance of all audio playing devices. Therefore, if at least one of the audio playing devices has lower performance, the overall presentation delay will be correspondingly set to be longer, which will limit the effectiveness of the audio playing devices which have higher performance.

Please return to FIG. 1. If the second audio playing device EP_2 has received a ready notification representing that the first audio playing device EP_1 is in the ready state, and has received the audio data output by the audio source device M and is ready to play the audio data. A start playing notification is sent through the OOB wireless communication channel CH_O to notify the first audio playing device EP_1 that it can start playing. After the first audio playing device EP_1 receives the start playing notification, the first audio playing device EP_1 and the second audio playing device EP_2 start playing the audio data. Such process can be called synchronization of audio playing devices.

In one embodiment, if the first audio playing device EP_1 detects that the first time difference is less than a difference threshold while waiting for start playing notifications from other audio playing devices, the first audio playing device EP_1 starts playing audio data. If the difference threshold is zero, it means that when the current time point reaches the first expected playing time point, the first audio playing device EP_1 no longer waits for the second audio playing device EP_2 and starts playing the audio data. In one embodiment, after the first audio playing device EP_1 and the second audio playing device EP_2 start playing the audio data, the first audio playing device EP_1 or the second audio playing device EP_2 continues to compute an actual playing time point of the audio data, and to compute a second expected playing time point of the audio data. If the number of times for that the actual playing time point lags after the second expected playing time point is greater than a number threshold, the aforementioned synchronization steps are performed again to adjust the “start playing time points” of the first audio playing device EP_1 and the second audio playing device EP_2. In one embodiment, the second expected playing time point is also computed based on the presentation delay specified in the basic audio specification.

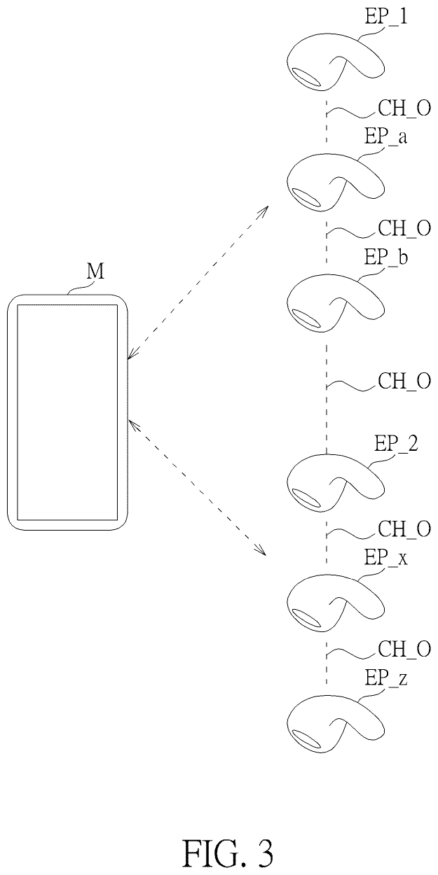

The embodiment in FIG. 1 is illustrated with two audio playing devices. However, the concept of the present invention can also be applied to more than two audio playing devices. FIG. 3 is a schematic diagram illustrating an audio system control method according to another embodiment of the present invention. As shown in FIG. 3, the audio system further comprises at least one third audio playing device EP_a, EP_b . . . EP_x in addition to the first audio playing device EP_1 and the second audio playing device EP_2. Each audio playing device can communicate with each other through the aforementioned OOB wireless communication channel CH_O. Therefore, in the embodiment of FIG. 3, each audio playing device EP_1 can send a ready notification to each other audio device through the OOB wireless communication channel CH_O (such action can also be called broadcast). In one embodiment, the second audio playing device enters the standby state in a latest moment among all the audio playing devices in the audio system. That is to say, in the embodiment of FIG. 3, the audio playing device that enters the standby state in a latest moment notifies other audio playing devices to start playing audio data, and other audio playing devices do not notify other audio playing devices to start playing audio.

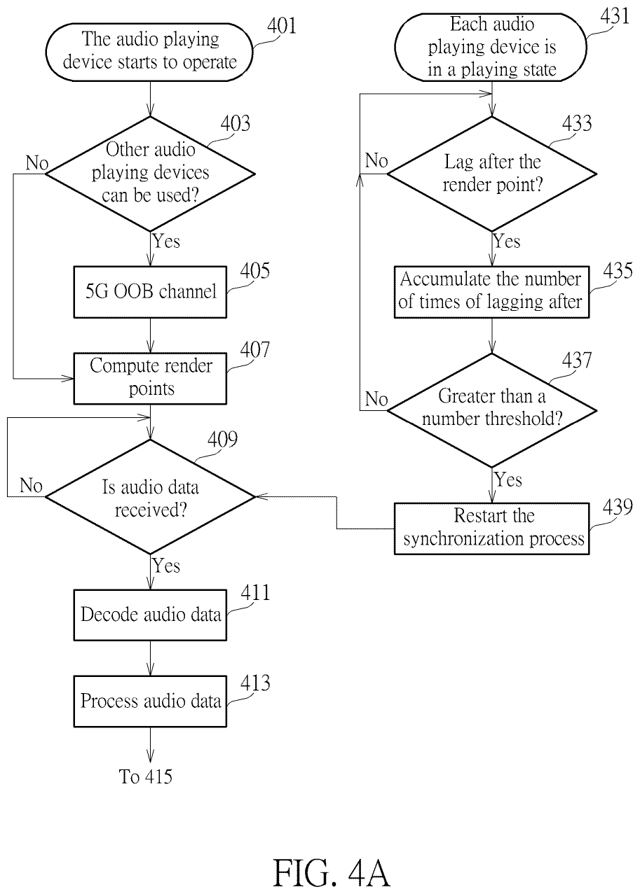

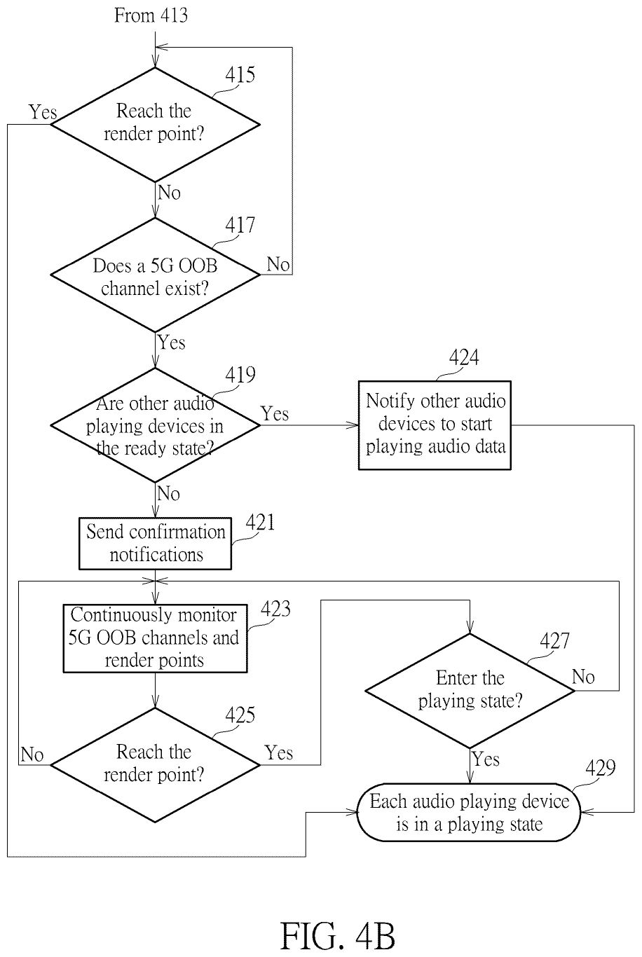

FIG. 4A and FIG. 4B are detail flow charts of operations of the audio system in FIG. 1 and FIG. 2, according to one embodiment of the present application. Please refer to FIG. 4A and FIG. 4B together to understand the present invention for more clarity. However, please note that FIGS. 4A and 4B take a 5G network and a Bluetooth device as examples for illustration, but do not mean to limit the scope of the present invention.

FIG. 4A and FIG. 4B comprise the following steps:

### Step 401

The audio playing device starts to operate.

### Step 403

Confirm whether there are other audio playing devices that can use the setting mechanism of the present invention. For example, confirm whether there are other audio playing devices containing ICs (Integrated Circuits) designed to implement the present invention.

If not, the OOB wireless communication channel cannot be established between the audio playing devices, so step 407 is performed.

If yes, go to step 405.

### Step 405

Establish a 5G OOB channel between audio playing devices.

### Step 407

Compute render points based on presentation latency.

### Step 409

Is audio data received?

If yes, proceed to the next step 411, if not, stay in step 409 and continue to confirm whether audio data is received.

As mentioned above, the audio data may be in SDU format.

### Step 411

Decode audio data.

### Step 413

Process audio data.

For example, the audio data can be resampled or equalized.

### Step 415

Does the time reach the render point?

If not, go to next step 417; if yes, go to step 429.

### Step 417

Does a 5G OOB channel exist?

If not, go back to step 415; if yes, go to step 419.

### Step 419

Are other audio playing devices in the ready state?

If not, go to step 421; if yes, go to step 429.

### Step 421

Each audio playing device successively sends confirmation notifications through the 5G OOB channel to inform that they are in the ready state.

### Step 423

Continuously monitor 5G OOB channels and render points.

### Step 424

Notify other audio devices to start playing audio data.

### Step 425

Does the time reach the render point?

If not, go back to step 423, if yes, go to step 427.

### Step 427

Does any audio playing device enter the playing state?

If yes, go to step 429, if not, go to step 423.

### Step 429

Each audio playing device is in a playing state.

### Step 431

Each audio playing device is in a playing state.

Steps 431 to 439 are steps for resynchronizing the audio playing device after the audio playing device enters the playing state. Step 431 and step 429 can be regarded as the same step.

### Step 433

Does the actual playing time point lag after the render point (one example of the second expected playing time point mentioned above)?

If not, go back to step 433; if yes, go to step 435.

### Step 435

Accumulate the number of times that the actual playing time point lags after the render point.

### Step 437

The number of times behind is greater than a number threshold?

If yes, go to step 439, if not, go to step 433.

### Step 439

Restart the synchronization process and return to step 409.

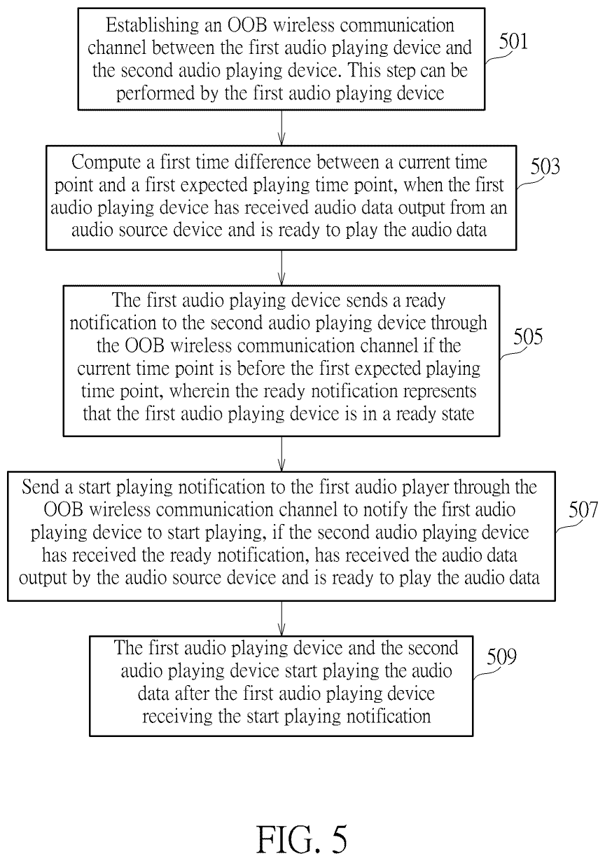

According to the foregoing embodiments, a simplified audio system control method can be obtained. FIG. 5 is a flow chart illustrating an audio system control method according to one embodiment of the present invention., which is used in an audio system comprising a first audio playing device and a second audio playing device (such as the audio system shown in FIG. 1). The flowchart shown in FIG. 5 contains the following steps:

### Step 501

Establishing an OOB wireless communication channel (e.g., OOB wireless communication channel CH_O) between the first audio playing device and the second audio playing device. This step can be performed by the first audio playing device.

### Step 503

Compute a first time difference between a current time point and a first expected playing time point, when the first audio playing device has received audio data output from an audio source device and is ready to play the audio data

### Step 505

The first audio playing device sends a ready notification to the second audio playing device through the OOB wireless communication channel if the current time point is before the first expected playing time point, wherein the ready notification represents that the first audio playing device is in a ready state.

### Step 507

Send a start playing notification to the first audio player through the OOB wireless communication channel to notify the first audio playing device to start playing, if the second audio playing device has received the ready notification, has received the audio data output by the audio source device and is ready to play the audio data.

### Step 509

The first audio playing device and the second audio playing device start playing the audio data after the first audio playing device receiving the start playing notification.

In one embodiment, after the first audio playing device and the second audio playing device start playing the audio data, the first audio playing device or the second audio playing device continues to compute an actual playing time point and a second expected playing time point of the audio data, and if the number of times that the actual playing time point lags after the second expected playing time point is greater than a number threshold, steps 503 to 509 are performed again.

In one embodiment, the audio system further comprises at least a third audio playing device (such as the third audio playing device EP_a, EP_b in the embodiment of FIG. 3) in addition to the first audio playing device and the second audio playing device. In such case, the step 507 further sends a ready notification to the third audio playing device, wherein the second audio playing device enters the ready state in a latest moment among all the audio playing devices in the audio system.

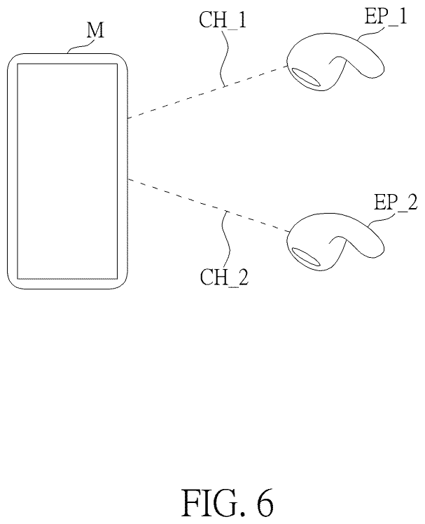

In the foregoing embodiments, an OOB wireless communication channel is established between audio playing devices. However, the audio playing devices can also be synchronized without an OOB wireless communication channel between the audio playing devices. FIG. 6 is a schematic diagram illustrating an audio system control method according to another embodiment of the present invention. As shown in FIG. 6, the audio system comprises a first audio playing device EP_1 and a second audio playing device EP_2. The first audio playing device EP_1 and a second audio playing device EP_2 can receive audio data from an audio source device M. In one embodiment, the audio source device M is a mobile device (such as a mobile phone), and the first audio playing device EP_1 and the second audio playing device EP_2 are Bluetooth earphones.

In the embodiment of FIG. 6, the OOB wireless communication channel CH_O is not established between the first audio playing device EP_1 and the second audio playing device EP_2 as shown in FIG. 1. Wireless communication channels CH_1 and CH_2 are respectively established between the first audio playing device EP_1 and the second audio playing device EP_2 and the audio source device M. In one embodiment, the wireless communication channels CH_1 and CH_2 are 5G OOB channels. If the first audio playing device EP_1 and the second audio playing device EP_2 are Bluetooth devices, the wireless communication channels CH_1 and CH_2 can also be wireless communication channels that follow the Bluetooth protocol. In the embodiment of FIG. 6, the playing actions of the first audio playing device EP_1 and the second audio playing device EP_2 are controlled by the audio source device M. For more detail, when the first audio playing device EP_1 and the second audio playing device EP_2 receive the first audio data output by the audio source device M and are ready to play the first audio data, the first audio playing device EP_1 and the second audio playing device EP_2 send the ready notification to the audio source device M through the wireless communication channels CH_1 and CH_2 respectively. When the audio source device M confirms that all audio playing devices are in the ready state, it generates a control command to the audio playing device to cause the audio playing device to start playing the first audio data.

After the first audio playing device EP_1 and the second audio playing device EP_2 start playing the audio data, the audio source device M collects the actual playing time at which the second audio data is played by the first audio playing device EP_1 and the second audio playing device EP_2. Also, the time differences between a plurality of actual playing times are computed. If the largest time difference is greater than a difference threshold, synchronization of the audio playing device is performed again.

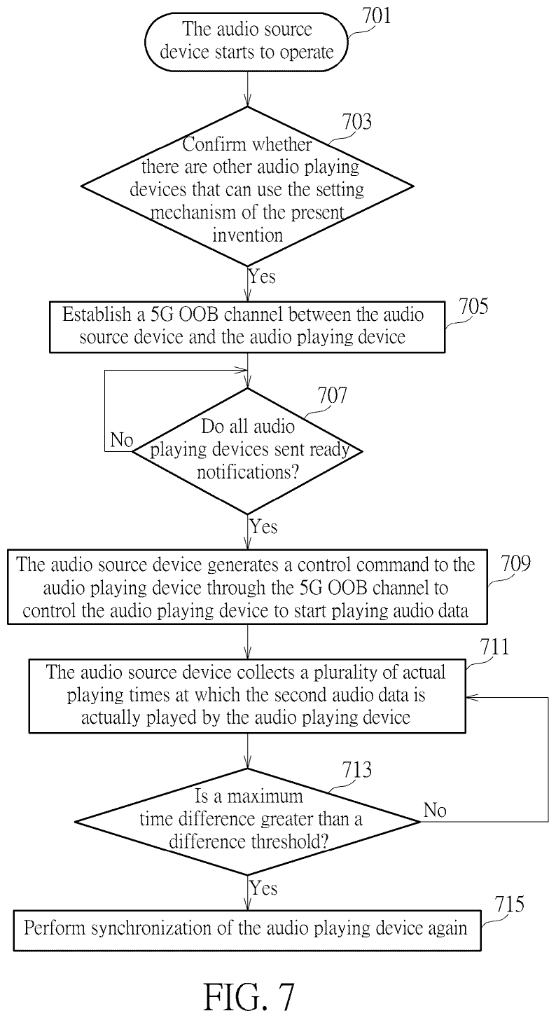

FIG. 7 is a detail flow chart of operations of the audio system in FIG. 6, according to one embodiment of the present application. However, please note that FIG. 7 takes a 5G network and a Bluetooth device as an example for illustration, but does not mean to limit the scope of the present invention.

FIG. 7 contains the following steps

### Step 701

The audio source device starts to operate.

### Step 703

Confirm whether there are other audio playing devices that can use the setting mechanism of the present invention. For example, confirm whether there are other audio playing devices containing ICs designed to implement the present invention.

If not, the mechanism of the present invention cannot be used between the audio source device and the audio playing device, so the execution can be stopped.

If yes, go to step 705.

### Step 705

Establish a 5G OOB channel between the audio source device and the audio playing device.

### Step 707

Do all audio playing devices sent ready notifications?

If yes, go to step 709, if not, stay in step 707 and continue waiting.

### Step 709

The audio source device generates a control command to the audio playing device through the 5G OOB channel to control the audio playing device to start playing audio data.

### Step 711

The audio source device collects a plurality of actual playing times at which the second audio data is actually played by the audio playing device.

### Step 713

Is a maximum time difference greater than a difference threshold?

If yes, go to step 715, if not, go to step 711.

### Step 715

Perform synchronization of the audio playing device again.

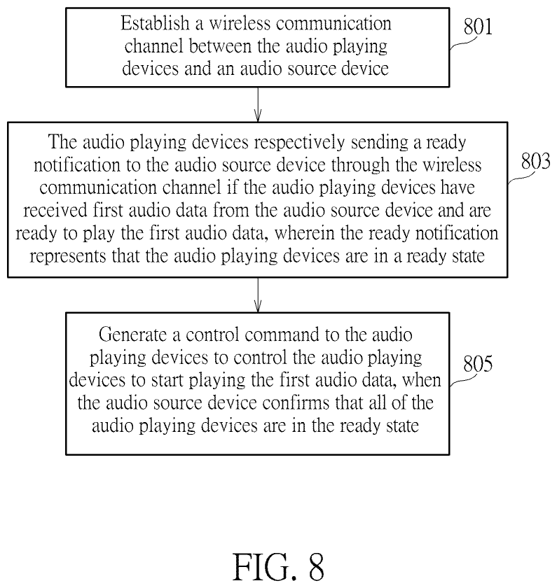

According to the embodiments of FIGS. 6 and 7, a summary flow chart of the audio system control method provided by the present invention can be obtained. FIG. 8 is a flow chart illustrating an audio system control method according to another embodiment of the present invention. The method can be applied to an audio system comprising multiple audio playing devices (such as the audio system shown in FIG. 6). The flowchart shown in FIG. 8 contains the following steps:

### Step 801

Establish a wireless communication channel (such as wireless communication channel CH_1, CH_2) between the audio playing devices and an audio source device

### Step 803

The audio playing devices respectively sending a ready notification to the audio source device through the wireless communication channel if the audio playing devices have received first audio data from the audio source device and are ready to play the first audio data, wherein the ready notification represents that the audio playing devices are in a ready state

### Step 805

Generate a control command to the audio playing devices to control the audio playing devices to start playing the first audio data, when the audio source device confirms that all of the audio playing devices are in the ready state.

In one embodiment, after the audio playing device starts playing the audio data, it collects the actual playing times at which the second audio data is played by the audio playing devices, and compute the time difference between the actual playing times. If the maximum time difference is greater than a difference threshold, step 803 and step 805 are executed again. That is, synchronization of the audio playing device is executed again.

In view of above-mentioned embodiments, the synchronization of different Bluetooth earphones is not limited by the presentation delay in the Bluetooth protocol, which can improve the problem in the prior art that the performance of all Bluetooth earphones is limited by Bluetooth earphones with a lower performance.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. An audio system control method, applied to an audio system comprising a first audio playing device and a second audio playing device, comprising:
(a) establishing an OOB (out of band) wireless communication channel between the first audio playing device and the second audio playing device;
(b) computing a first time difference between a current time point and a first expected playing time point, when the first audio playing device has received audio data output from an audio source device and is ready to play the audio data;
(c) the first audio playing device sending a ready notification to the second audio playing device through the OOB wireless communication channel if the current time point is before the first expected playing time point, wherein the ready notification represents that the first audio playing device is in a ready state;
(d) sending a start playing notification to the first audio player through the OOB wireless communication channel to notify the first audio playing device to start playing, if the second audio playing device has received the ready notification, has received the audio data output by the audio source device and is ready to play the audio data; and
(e) the first audio playing device and the second audio playing device start playing the audio data after the first audio playing device receiving the start playing notification.

2. The audio system control method of claim 1, wherein the OOB wireless communication channel is a 5G OOB channel.

3. The audio system control method of claim 1, wherein the first audio playing device and the second audio playing device are Bluetooth devices, and the step (b) computes the first expected playing time point based on the current time point and a presentation delay specified in the Basic Audio Profile.

4. The audio system control method of claim 1, wherein the audio system further comprises at least a third audio playing device in addition to the first audio playing device and the second audio playing device, and the step (c) further sends the ready notification to the third audio playing device, wherein the second audio playing device enters the ready state in a latest moment among all audio playing devices in the audio system.

5. The audio system control method of claim 1, wherein if the first audio playing device detects that the first time difference is less than a difference threshold while waiting for the start playing notification, the first audio playing device starts playing the audio data.

6. The audio system control method of claim 1, wherein after the first audio playing device and the second audio playing device start playing the audio data, the first audio playing device or the second audio playing device computing an actual playing time point and a second expected playing time point of the audio data, and if a number of times for that the actual playing time point is after the second expected playing time point is greater than a number threshold, performing the step (b), the step (c), the step (d), and the step (e) again.

7. The audio system control method of claim 1, wherein the audio source device is a mobile device, and the first audio playing device and the second audio playing device are Bluetooth earphones.

8. An audio system control method, applied to an audio system comprising a plurality of audio playing devices, comprising:
(a) establishing a wireless communication channel between the audio playing devices and an audio source device;
(b) the audio playing devices respectively sending a ready notification to the audio source device through the wireless communication channel if the audio playing devices have received first audio data from the audio source device and are ready to play the first audio data, wherein the ready notification represents that the audio playing devices are in a ready state; and
(c) generating a control command to the audio playing devices to control the audio playing devices to start playing the first audio data, when the audio source device confirms that all of the audio playing devices are in the ready state.

9. The audio system control method of claim 8, wherein the wireless communication channel is a 5G OOB (out of band) channel.

10. The audio system control method of claim 8, further comprising:
collecting actual playing times at which the audio playing devices actually playing the second audio data, after the audio playing devices start playing the audio data;
computing time differences between the actual playing times;
performing the step (b) and the step (c) again if a maximum one among the time differences is larger than a difference threshold.

11. The audio system control method of claim 8, wherein the audio source device is a mobile device, the first audio playing device and the second audio playing device are Bluetooth earphones.

12. An audio system, comprising:
a first audio playing device; and
a second audio playing device;
wherein the audio system performs following steps:
(a) the first audio playing device establishing an OOB wireless communication channel between the first audio playing device and the second audio playing device;
(b) the first audio playing device computing a first time difference between a current time point and a first expected playing time point, when the first audio playing device has received audio data output from an audio source device and is ready to play the audio data;
(c) the first audio playing device sends a ready notification to the second audio playing device through the OOB wireless communication channel if the current time point is before the first expected playing time point, wherein the ready notification represents that the first audio playing device is in a ready state;
(d) the second audio playing device sends a start playing notification to the first audio player through the OOB wireless communication channel to notify the first audio playing device to start playing, if the second audio playing device has received the ready notification, has received the audio data output by the audio source device and is ready to play the audio data;
(e) the first audio playing device and the second audio playing device start playing the audio data after the first audio playing device receiving the start playing notification.

13. The audio system of claim 12, wherein the OOB wireless communication channel is a 5G OOB channel.

14. The audio system of claim 12, wherein the first audio playing device and the second audio playing device are Bluetooth devices, and the step (b) computes the first expected playing time point based on the current time point and a presentation delay specified in the Basic Audio Profile.

15. The audio system of claim 12, wherein the audio system further comprises at least a third audio playing device in addition to the first audio playing device and the second audio playing device, and the step (c) further sends the ready notification to the third audio playing device, wherein the second audio playing device enters the ready state in a latest moment among all audio playing devices in the audio system.

16. The audio system of claim 12, wherein if the first audio playing device detects that the first time difference is less than a difference threshold while waiting for the start playing notification, the first audio playing device starts playing the audio data.

17. The audio system of claim 12, wherein after the first audio playing device and the second audio playing device start playing the audio data, the first audio playing device or the second audio playing device computing an actual playing time point and a second expected playing time point of the audio data, and if a number of times for that the actual playing time point is after the second expected playing time point is greater than a number threshold, performing the step (b), the step (c), the step (d), and the step (e) again.

18. The audio system of claim 12, wherein the audio source device is a mobile device, and the first audio playing device and the second audio playing device are Bluetooth earphones.
